(19) United States
(12) Patent Application Publication
(10) Pub. No.: US 2025/0239620 A1
(43) Pub. Date: Jul. 24, 2025

(54) ELECTRODE PLATE, ELECTRODE ASSEMBLY AND RECHARGEABLE BATTERY INCLUDING THE ELECTRODE ASSEMBLY

(71) Applicant: SAMSUNG SDI CO., LTD., Gyeonggi-do (KR)

(72) Inventor: Jinkyu CHOI, Gyeonggi-do (KR)

(73) Assignee: SAMSUNG SDI CO., LTD., Gyeonggi-do (KR)

(21) Appl. No.: 18/920,105

(22) Filed: Oct. 18, 2024

(30) Foreign Application Priority Data
Jan. 19, 2024 (KR) 10-2024-0009105

(51) Int. Cl. H01M 4/66; H01M 10/0585; H01M 50/105

(52) U.S. Cl. CPC H01M 4/667; H01M 4/662; H01M 4/663; H01M 4/668; H01M 10/0585; H01M 50/105

(57) ABSTRACT

An electrode plate according to example embodiments includes a base layer, a first conductive layer, a current collecting layer including a first conductive layer and a second conductive layer respectively disposed on an upper surface and a lower surface of the base layer, and an electrode plate layer disposed on at least one side of the current collecting layer, wherein at least a portion of the first conductive layer and at least a portion of the second conductive layer extending beyond the base layer are coupled to each other.

### CROSS-REFERENCE TO RELATED APPLICATION

This application claims the benefit of priority to Korean Patent Application No. 10-2024-0009105 filed in the Korean Intellectual Property Office on Jan. 19, 2024, the entire contents of which are incorporated herein by reference.

### BACKGROUND OF THE INVENTION

### (a) Field of the Invention

The present disclosure relates to an electrode plate, an electrode assembly, and a rechargeable battery including the electrode assembly.

### (b) Description of the Related Art

A rechargeable battery is manufactured in various shapes. A pouch-type battery typically includes an electrode assembly formed of or including a positive electrode plate, a negative electrode plate, and an insulator separator between the positive electrode plate and the negative electrode plate, and a thin flexible pouch in which the electrode assembly is embedded. In this case, the pouch accommodates the electrode assembly in an inner space.

The electrode assembly of the rechargeable battery is largely divided into winding type and stacking type depending on its structure. The stacking type has good structural safety and improved spatial utility, and thus the stacking type rechargeable battery is widely applied to a small and medium-sized product. The stacking-type rechargeable battery is a stack of a plurality of electrode plates and a separator.

A current collecting layer applied to electrodes, that is, a positive electrode and a negative electrode of the rechargeable battery may usually be a thin film with electrical conductivity such as copper (Cu), aluminum (AI), nickel (Ni), or stainless steel (SUS). For example, in the case of a commercially available lithium ion battery, a copper foil current collecting layer is typically used for the negative electrode and an aluminum foil current collecting layer is typically used for the positive electrode.

In some cases, in order to lower the manufacturing cost and reduce the weight of rechargeable batteries, the current collecting layer is not manufactured entirely from copper or aluminum, but a current collecting layer with a metal layer applied to both sides of a resin is also used.

In a resin metal composite substrate, metal layers are on both sides of the resin sheet, and the resin has a low conductivity, and as a result a disadvantage occurs in that the metal layers on both sides do not conduct electricity to each other.

### SUMMARY OF THE INVENTION

The present disclosure is intended to address the disadvantages described above, and example embodiments include an electrode plate that can implement conductivity between adjacent electrode plates, an electrode assembly, and a rechargeable battery including the electrode assembly.

The technical object that the present disclosure seeks to address is not limited to the above-mentioned problems, and other problems not mentioned can be clearly understood by a person of an ordinary skill in the art from the description of the invention described below.

An electrode plate according to an example embodiment of the present disclosure includes a base layer, a first conductive layer, a current collecting layer including a first conductive layer and a second conductive layer respectively located on an upper surface and a lower surface of the base layer, and an electrode plate layer on at least one side of the current collecting layer, wherein a portion of the first conductive layer and a portion of the second conductive layer extending beyond the base layer are coupled to each other.

The base layer may include a body portion; and an inclined portion that is integrated with the body portion, a thickness of the inclined portion gradually decreases toward the end.

The current collecting layer may include a current collecting portion having an electrode plate layer on at least one side, and an uncoated region extending to the outside from the current collecting portion, and a portion of the first conductive layer and a portion of the second conductive layer may extend beyond the uncoated region, and ends thereof may be coupled to each other.

The base layer may include at least one of poly amide, poly imide, poly butylene terephthalate, polyethylene naphthalate, poly carbonate, polyethylene, polypropylene, polyethylene propylene, acrylo nitrile-butadiene-styrene copolymer, poly vinyl alcohol, poly styrene, poly chloride vinyl, poly vinylidene fluoride, poly tetra fluoro ethylene, poly styrene sulfonate sodium, poly acetylene, silicon rubber, poly oxy methylene, poly phenylene ether, poly phenylene sulfide, polyethylene glycol, poly sulfur nitride, poly phenylene, polypyrrole, poly aniline, polythiophene, polypyridine, cellulose, farinaceous, protein, epoxy resin, phenol resin, a derivative thereof, a replacement of the above-stated material, and a copolymer thereof.

The base layer may further include an additive, wherein the additive may include one or more of a metal material and an inorganic non-metal material.

The first conductive layer and the second conductive layer may contain aluminum.

The first conductive layer and the second conductive layer may contain one or more of nickel, copper, iron, and alloys containing at least nickel, copper and iron.

The first conductive layer and the second conductive layer may contain one or more of a metal material, a carbon-based conductive material, and a conductive polymer material.

An electrode assembly according to an example embodiment includes a plurality of electrode plates and a separator, the plurality of electrode plates are stacked with the separator therebetween, and each of the plurality of electrode plates may include a current collecting layer including a base layer, a first conductive layer and a second conductive layer on an upper surface and a lower surface of the base layer respectively, extend longer than the base layer and are partially combined with each other, and an electrode plate layer in a portion of the current collecting layer.

A thickness of one end of the base layer may gradually decrease.

The base layer may include a body portion and an inclined portion that is integrated with the body portion, a thickness of which gradually decreases toward the end.

Current collecting layers contained in the plurality of electrode plates may be combined with each other.

The current collecting layer may include a current collecting portion having an electrode plate layer on at least one side, and an uncoated region extending to the outside from the current collecting portion.

The plurality of electrode plates may include a first electrode plate and a second electrode plate.

The base layer may include at least one of poly amide, poly imide, poly butylene terephthalate, polyethylene naphthalate, poly carbonate, polyethylene, polypropylene, polyethylene propylene, acrylo nitrile-butadiene-styrene copolymer, poly vinyl alcohol, poly styrene, poly chloride vinyl, poly vinylidene fluoride, poly tetra fluoro ethylene, poly styrene sulfonate sodium, poly acetylene, silicon rubber, poly oxy methylene, poly phenylene ether, poly phenylene sulfide, polyethylene glycol, poly sulfur nitride, poly phenylene, polypyrrole, poly aniline, polythiophene, polypyridine, cellulose, farinaceous, protein, epoxy resin, phenol resin, a derivative thereof, a replacement of the above-stated material, and a copolymer thereof.

The base layer may further include an additive, wherein the additive may include one or more of a metal material and an inorganic non-metal material.

The first conductive layer and the second conductive layer may contain aluminum.

The first conductive layer and the second conductive layer my contain one or more of nickel, copper, iron, and alloys thereof.

The first conductive layer and the second conductive layer may contain one or more of a metal material, a carbon-based conductive material, and a conductive polymer material.

A rechargeable battery according to an example embodiment includes an electrode assembly and a case accommodating the electrode assembly.

According to example embodiments, in the current collecting layer included in the electrode assembly, parts of the first conductive layer and the second conductive layer are coupled with each other. Accordingly, a plurality of electrode plates can be electrically connected to each other.

Accordingly, the electrode assembly according to an example embodiment does not need to perform a conduction process that requires additional folding of foil and insertion between electrode plates one by one, as discussed above. Therefore, not only can the manufacturing time be shortened, but the manufacturing cost can also be reduced.

### BRIEF DESCRIPTION OF THE DRAWINGS

The following drawings attached to this specification illustrate example embodiments of the present disclosure, and together with the detailed description of the invention described later, serve to further understand the technical idea of the present disclosure, and thus the example embodiments should not be construed as limited to the matters described in such drawings.

FIG. 1 is a perspective view of a rechargeable battery in which an electrode plate and an electrode assembly including the electrode plate according an example embodiment are installed.

FIG. 2 is a cross-sectional view of a state in which the plurality of electrode plates are coupled to each other.

FIG. 3 is a perspective view of the electrode plate of the rechargeable battery of FIG. 1.

FIG. 4 is a cross-sectional view that illustrates a process of manufacturing the current collecting layer of the electrode plate of FIG. 3.

FIG. 5 is a cross-sectional view of a current collecting layer according to an example variation.

FIG. 6 and FIG. 7 show a process for manufacturing an electrode assembly.

FIG. 6 is a cross-sectional view of electrode plates in parallel in the vertical direction.

FIG. 7 is a cross-sectional view of a process of welding the uncoated regions of the plurality of current collecting layers respectively by ultrasonic welding.

### DETAILED DESCRIPTION OF THE EMBODIMENTS

Hereinafter, example embodiments of the present disclosure will be described in detail with reference to the attached drawings. Prior to the detailed description of the example embodiments, the terms or words used in this specification and claims range described below should not be construed as being limited to conventional or dictionary meanings, and the inventor should be interpreted as meaning and concept consistent with the technical idea of the present disclosure based on the principle that it can be appropriately defined as a concept of a term to describe his/her own invention in the best way. Therefore, example embodiments described in the present specification and the configurations shown in the drawings are only example embodiments of the present disclosure, and do not represent all the technical spirit of the present disclosure, and therefore, it should be understood that various equivalents and modifications may be substituted for the example embodiments at the time of filing the present application.

In addition, when used in this specification, “comprise, include” and/or “comprising, including” refers to specify the presence of the mentioned shapes, numbers, steps, operations, members, elements and/or these groups, and it does not exclude the presence or addition of one or more other shapes, numbers, movements, members, elements and/or groups.

In addition, to aid understanding of the invention, the attached drawings may not be drawn to actual scale, but the dimensions of some components may be exaggerated. Further, the same reference number may be assigned to the same component in another embodiment.

The statement that two objects of comparison are “the same” means “substantially the same”. Therefore, substantial identity may include a deviation that is considered low in the industry, for example, a deviation of less than 5%. In addition, uniformity of a parameter in a given region may mean uniformity from an average perspective.

Although first, second, and the like are used to describe various configurations elements, these components are of course not limited by these terms. These terms are only used to distinguish one component from another component, and unless specifically stated to the contrary, a first component may also be a second component.

Throughout the specification, unless otherwise stated, each component may be singular or plural.

The placement of any component on the “upper portion (or lower portion)” of a component or the “top (or bottom)” of a component means not only that any component may be placed in contact with an upper surface (or lower surface) of the component but also that that other configurations may be interposed between and any configuration placed on (or under) the component.

In addition, when a component is described as “on,” “connected to,” or “coupled to” another component, the components may be directly connected or connected to each other. However, it should be understood that other components may be “disposed” between each component, or that each component may be “connected,” “coupled,” or “accessed” through other components.

As used in this specification, the term “and/or” includes any and all combinations of one or more of the associated listed items. In addition, the use of “may” when describing embodiments of the present disclosure refers to “one or more embodiments of the present disclosure.”

Expressions such as “one or more” and “one or more” preceding a list of elements modify the entire list of elements and do not modify individual elements in the list.

When the expression “A and/or B” is used throughout the specification, it means A, B, or A and B, unless specifically stated to the contrary, and the expression “C to D” means that it is higher than C and lower than D unless specifically stated to the contrary.

When a syntax like “at least one selected from A, B and C”, “at least one selected from A, B or C”, “at least one selected from A, B and C group” and “at least one selected from A, B and C” is used to specify a list of elements A, B, and C, the syntax may refer to any and all suitable combinations.

The term “use” may be considered synonymous with the term “utilize.”

As used in this specification, “substantially,” “approximately,” and similar terms are used as terms of approximation rather than terms of degree and for consideration of inherent variations in measured or calculated values as would be recognized by a person of ordinary skill in the art.

In this specification, the terms first, second, third, and the like may be used to describe various elements, components, regions, layers and/or sections, but these elements, components, regions, layers and/or sections should not be limited by these terms. This term is used to distinguish one element, component, region, drawing layer or cross-section from another element, component, region, drawing layer or cross-section. Accordingly, the first element, component, region, layer or section discussed below may be named a second element, component, region, layer or section without departing from the teachings of the example embodiments.

As shown in the drawing, to describe the relationship between one element or feature and other element(s) or feature(s), for ease of description, spatial relative terms such as “beneath,” “below,” “lower”, “above”, “upper”, and the like may be used in this specification. The spatially relative position will be understood to encompass different directions of a device in use or operation in addition to the direction depicted in the figures. For example, when the device in the drawing is flipped, an element described as “below” or “bottom” is understood to be “above” or “above” another element. Therefore, the term “below” may encompass both up and down directions.

The terms used in this specification are intended to describe example embodiments of the present disclosure and are not intended to limit the present disclosure.

Hereinafter, a rechargeable battery including an electrode plate will be described in detail before describing the electrode plate according to an example embodiment of the present disclosure.

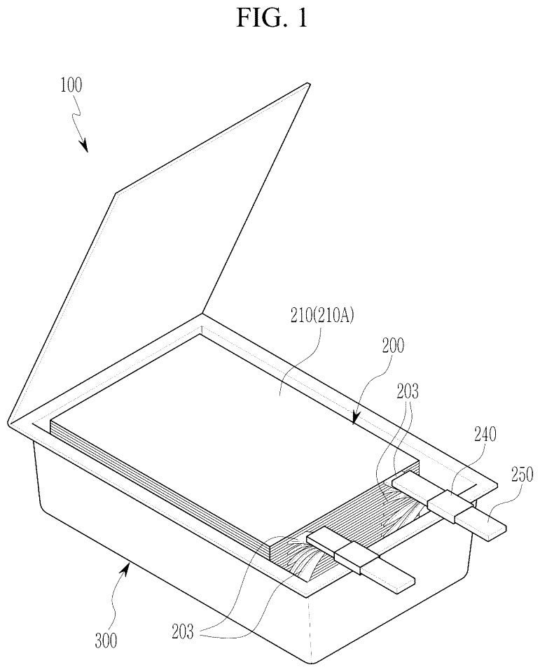

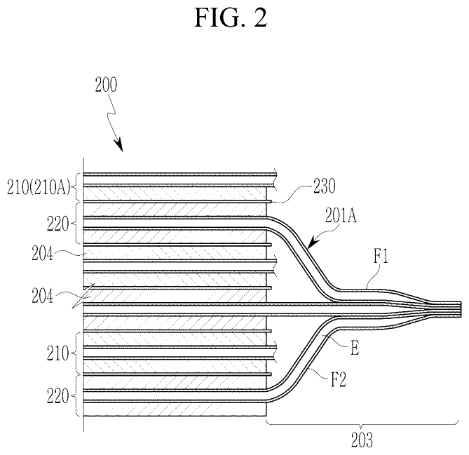

FIG. 1 is a perspective view of a rechargeable battery in which an electrode plate according to an example embodiment of the present disclosure and an electrode assembly including the electrode assembly can be installed, and FIG. 2 is a cross-sectional view of a state in which a plurality of electrode plates are coupled to each other.

Referring to FIG. 1 and FIG. 2, a rechargeable battery 100 may include an electrode assembly 200 and a case 300.

The electrode assembly 200 includes a plurality of electrode plates 210 and 220 and a separator 230. More specifically, the plurality of electrode plates 210 and 220 may include a first electrode plate 210 and a second electrode plate 220.

The electrode assembly 200 may be or include a laminate including the first electrode plate 210, the second electrode plate 220, and the separator 230 and repeatedly wound or stacked.

For example, the electrode assembly 200 may be a stacked type electrode assembly in which the electrode plates 210 and 220 are arranged to be stacked in multiple layers. Alternatively, the electrode assembly 200 may be a repeatedly wound jelly-roll type. In example embodiments, the electrode assembly 200 is a stacked type as an example.

Meanwhile, a manufacturing process of the stacked type electrode assembly 200 generally involves a primary stacking process and a secondary process.

In the primary stacking process, a full cathode and a full anode may be stacked. Here, the full cathode may be or include the first electrode plates 210 except the outermost first electrode plate 210A. In addition, the full anode may be the second electrode plate 220.

In the secondary lamination process, a half cathode may be laminated on one or more of the lateral outermost sides thereof using the lamination direction as a reference. For example, the half cathode may be or include the outermost first electrode plate 210A among the first electrode plates 210.

For convenience of description, in FIG. 2, the electrode assembly 200 includes a half cathode stacked on the outermost of the electrode assembly 200, it may also be possible that the half cathode is stacked on the upper outermost and lateral outermost sides of the electrode assembly 200, respectively.

Here, the full cathode and the full anode are those in which active material is applied to both sides of the substrate, and the half cathode is one in which the electrode layer is positioned on only one side of the current collecting layer. Here, the electrode plate layer may be or include an active material layer. Detailed descriptions of such full cathodes, full anodes, and half cathodes will be omitted.

The separator 230 may be located between the first electrode plate 210 and the second electrode plate 220. The separator 230 may reduce or prevent a short circuit between the first electrode plate 210 and the second electrode plate 220, and enables the movement of lithium ions. To this end, the separator 230 may be relatively larger in size than the first electrode plate 210 or the second electrode plate 220.

A material of the separator 230 may be or include, for example, at least one of polyethylene, polypropylene, or a composite film of polyethylene and polypropylene, but is not limited thereto.

The separator 230 may be cut to unit length and placed between the first electrode plate 210 and the second electrode plate 220, or a single separator 230 having a ribbon shape may be placed in a zigzag pattern between the first electrode plate 210 and the second electrode plate 220. Alternatively, the separator 230 may be wound in one direction between the first electrode plate 210 and the second electrode plate 220. The configuration of the separator 230 is not limited to a specific configuration.

The case 300 may accommodate or include the electrode assembly 200. The electrode assembly 200 described above may be accommodated or included in the case 300 together with an electrolyte solution.

The case 300 described above may be one of pouch type, cylindrical type, and square type case. The pouch-type case 300 may be manufactured by bending plate-shaped exterior materials to face each other, then pressing or drawing one side, and including a recess on one side.

The electrode assembly 200 is accommodated or included in the recess (not shown). A sealing portion is provided on an exterior circumferential surface of the recess, and with the electrode assembly 200 accommodated in the recess, the sealing portion is sealed using a method such as, e.g., heat coalesce.

Meanwhile, in the plurality of electrode plates 210 and 220, the above-described first electrode plate 210 may be or include a negative electrode, and the second electrode plate 220 may be or include an anode, or vice versa. The first electrode plate 210 and the second electrode plate 220 may be electrically connected to the outside of the rechargeable battery 100 through a strip terminal 250. In addition, an insulation tape 240 may be attached to a portion of the strip terminal 250 that is in contact with the case 300. The insulation tape 240 may hinder or prevent the strip terminal 250 and the case 300 from being electrically connected.

Hereinafter, the electrode assembly 200 according to an example embodiment of the present disclosure will be described in more detail with reference to the drawings.

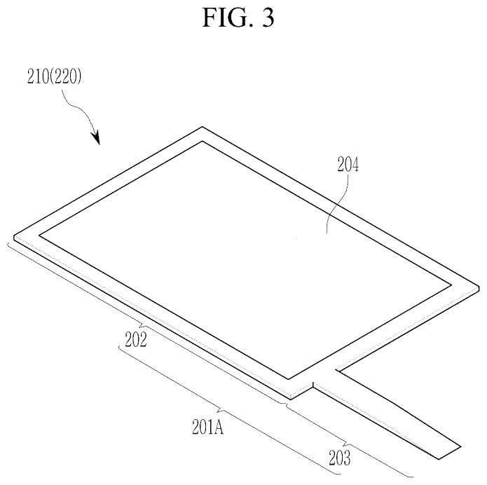

FIG. 2 is a cross-sectional view of a state in which the plurality of electrode plates are coupled to each other, and FIG. 3 is a perspective view of the electrode plate of the rechargeable battery of FIG. 1.

Referring to FIG. 2 and FIG. 3, as described above, the electrode assembly 200 according to an example embodiment includes the plurality of electrode plates 210 and 220, and each of the plurality of electrode plates 210 and 220 includes a current collecting layer 201A and an electrode plate layer 204 disposed in a portion of the current collecting layer 201A. In this example, the electrode plate layer 204 may be or include an electrode active material layer used in a general rechargeable battery, and thus a detailed description thereof is omitted.

The current collecting layer 201A includes a base layer E, a first conductive layer F1, and a second conductive layer F2 on upper and lower surfaces of the base layer E, respectively, using an internal structure as a reference.

The base layer E may include, for example, polyethylene terephthalate (PET).

Alternatively, the base layer E may include, for example, at least one of poly amide, poly imide, poly butylene terephthalate, polyethylene naphthalate, poly carbonate, polyethylene, polypropylene, polyethylene propylene, acrylo nitrile-butadiene-styrene copolymer, poly vinyl alcohol, poly styrene, poly chloride vinyl, poly vinylidene fluoride, poly tetra fluoro ethylene, poly styrene sulfonate sodium, poly acetylene, silicon rubber, poly oxy methylene, poly phenylene ether, poly phenylene sulfide, polyethylene glycol, poly sulfur nitride, poly phenylene, polypyrrole, poly aniline, polythiophene, polypyridine, cellulose, farinaceous, protein, epoxy resin, phenol resin, a derivative of the above-described material, a replacement of the above-described material, and a copolymer of the above-described material.

In examples, the base layer E may further include additives. The additives may contain one or more of a metal material and an inorganic non-metal material.

For example, the metal material additive may be or include one or more of aluminum, an aluminum alloy, copper, a copper alloy, nickel, a nickel alloy, titanium, a titanium alloy, iron, an iron alloy, silver, and a silver alloy.

In addition, the inorganic non-metal material additive is or includes one or more of, for example, a carbon-based material, oxidation aluminum, silicon oxide, silicon nitride, carbonization silicon, nitride boron, silicic acid salt, and oxidation titanium, and one or more of, for example, a glass material, a ceramic material, and a ceramic composite material. The carbon-based material additive may be or include, for example, one or more of graphite, superconducting carbon, acetylene black, carbon black, Ketjen black, carbon dot, carbon nanotube, graphene, and carbon nanofiber.

Meanwhile, the additive may further include a carbon-based material applied by a metal material. For example, the carbon-based material may be or include one or more of graphite powder coated with nickel and carbon fiber coated with nickel.

In examples, the first conductive layer F1 and the second conductive layer F2 may include aluminum. For example, the first conductive layer F1 and the second conductive layer F2 may include one or more of a metal material, a carbon-based conductive material, and a conductive polymer material.

As illustrated in FIG. 3, the current collecting layer 201A may include a current collecting portion 202 and an uncoated region 203 using an external shape as a reference.

The electrode plate layer 204 is on at least one side of the current collecting unit 202. The current collecting portion 202 may have, for example, a plate shape of a quadrangular shape. As shown in the example of FIG. 3, the electrode plate layer 204 may be in the remaining portion of the current collecting portion 202 but not at an edge region of the current collecting portion. Alternatively, although not shown in the drawing, the electrode plate layer 204 may be located throughout the current collecting portion 202.

The uncoated region 203 extends outward from the current collecting portion 202. The uncoated region 203 may be a portion where the electrode plate layer 204 is not positioned. The uncoated region 203 may have, for example, a ribbon shape.

In examples, the plurality of electrode plates 210 and 220 include the first electrode plate 210 and the second electrode plate 220, and a portion of the first conductive layer F1 and a portion of the second conductive layer F2 extend beyond the base layer E and are combined with each other in each current collecting layer 201A of the first electrode plate 210 and the second electrode plate 220. As shown in FIG. 2, a portion of the first conductive layer F1 and a portion of the second conductive layer F2 extend beyond the uncoated region 203, and the ends of the first conductive layer F1 and of the second conductive layer F2 are joined to each other.

Accordingly, when the current collecting layers 201A of the plurality of first electrode plate 210 are combined with each other, the plurality of first electrode plate 210 may be electrically connected. In addition, when the current collecting layers 201A of the plurality of second electrode plates 220 are combined with each other, the plurality of second electrode plates 220 may also be electrically connected.

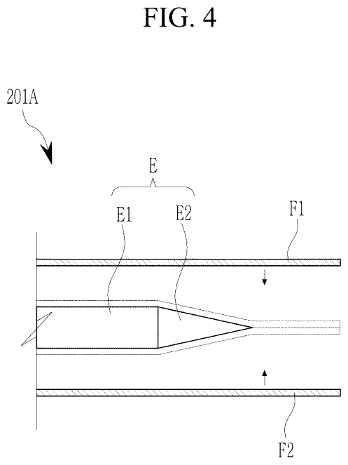

FIG. 4 is a cross-sectional view that illustrates a process of manufacturing the current collecting layer of the electrode plate of FIG. 3.

Referring to FIG. 4, the base layer E included in the current collecting layer 201A may include a body portion E1 and an inclined portion E2.

The body portion E1 has a substantially uniform thickness, unlike the inclined portion E2, which will be described later. The body portion E1 may be disposed in substantially the entire current collecting portion 202, and in a portion of the body portion E1. In another example, although not shown in the drawing, it may be possible for the body portion E1 to be positioned only in the current collecting portion 202.

The inclined portion E2 may be integrated with the body portion E1, and a thickness thereof gradually decreases toward the end. The shape of the vertical cross-section of the inclined portion E2 may be, for example, a triangle. The inclined portion E2 may extend from the current collecting layer 201A to a portion adjacent to an end of the uncoated region 203. Alternatively, the end of the inclined portion E2 may be at a middle portion of the uncoated region 203, and the remaining portion of the uncoated region 203 may be configured to combine the first conductive layer F1 and the second conductive layer F2.

As described above, a region where each of the body portion E1 and the inclined portion E2 in the current collecting layer 201A is located may vary depending on the design of the electrode assembly 200, and therefore the region is not limited to a specific location. In examples, it may be advantageous for the body portion E1 to be located in a large portion of the current collecting layer 201A in order to increase the rigidity of the current collecting layer 201A.

In examples, the above-described first conductive layer F1 and second conductive layer F2 are located on both sides of the body portion E1 and the inclined portion E2, and parts of the ends thereof are joined to each other, and thus the first conductive layer F1 and the second conductive layer F2 are electrically connected.

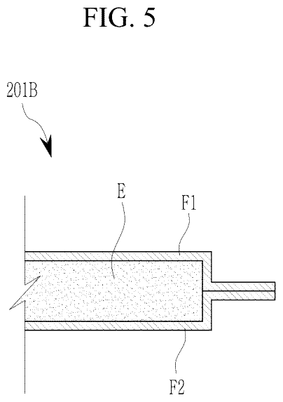

FIG. 5 is a cross-sectional view of a current collecting layer according to an example variation.

Referring to FIG. 5, a current collecting layer 201B according to an example variation may only include a body portion E1 without the inclined portion E2 unlike the example current collecting layer 201A illustrated in FIG. 4. The current collecting layer 201B according to the example variation may have a simpler manufacturing process than the current collecting layer 201A described above.

Referring back to FIG. 2, the plurality of electrode plates 210 and 220 may be combined with each other and may be adjacent to each other in the vertical direction between the uncoated regions 203.

In examples, when the electrode assembly 200 is a stacked type electrode assembly, the first electrode plate 210 and the second electrode plate 220 may be stacked alternately with a separator 230 therebetween. The first electrode plate 210 and the second electrode plate 220 may be provided in plurality. Although FIG. 2 illustrates three first electrode plates 210 and three second electrode plates 220, the number of first electrode plates 210 and the number of second electrode plates 220 may vary depending on the design of the rechargeable battery 100.

In the electrode assembly 200 according to an example embodiment, uncoated regions 203 of the first electrode plate 210 are located side by side in the vertical direction, and uncoated regions 203 of the second electrode plate 220 are located side by side in a horizontal direction and in the vertical direction. Although not shown in the drawing, the uncoated region 203 of the first electrode plate 210 may be spaced apart from the uncoated region 203 of the second electrode plate 220 in the horizontal or lateral directions.

In examples, the uncoated regions 203 described above may be joined together by, e.g., welding. For example, the plurality of uncoated regions 203 may be collected and joined by welding methods such as, e.g., laser, resistance welding, and ultrasonic welding.

In examples, a length of the uncoated region 203 is not limited to a specific value, and any length that allows the uncoated regions 203 to be combined with each other may be sufficient. Since the length of the uncoated region 203 may vary depending on the design of the electrode assembly 200, the length is not limited to a specific value.

Because an electrode plate included in the aforementioned electrode assembly 200 includes a current collecting layer 201A in which portions of the first conductive layer F1 and the second conductive layer F2 are combined with each other, the plurality of electrode plates 210 and 220 may be electrically conducted by welding, e.g., conducted only by welding, the uncoated regions 203 together.

A manufacturing process of the electrode assembly 200 according to the above example embodiment will be described with reference to the drawing.

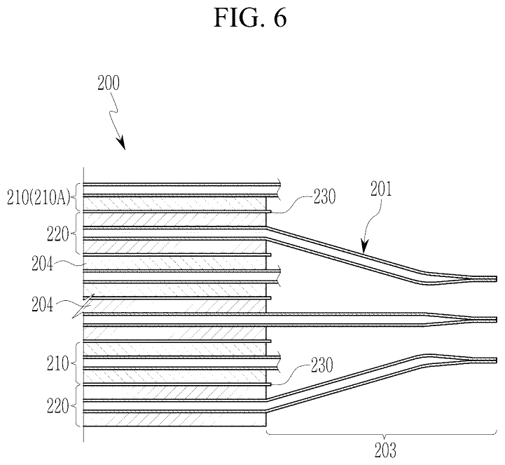

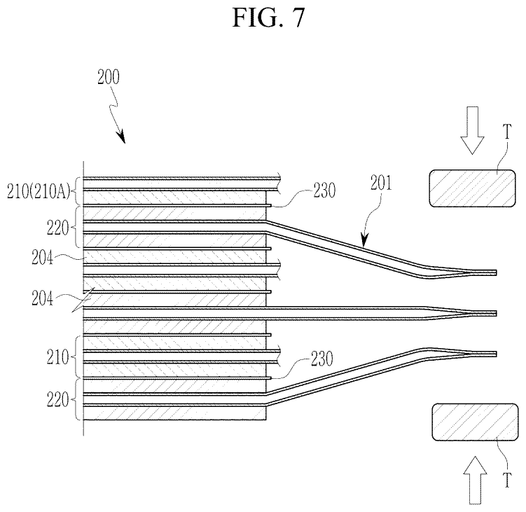

FIG. 6 and FIG. 7 show a process for manufacturing an electrode assembly.

FIG. 6 is a cross-sectional view of an electrode assembly having electrode plates located in parallel in the vertical direction.

Referring to FIG. 6, the first electrode plate 210 and the second electrode plate 220 are stacked, or arranged in a stacking configuration. The first electrode plate 210 and the second electrode plate 220 may be stacked, e.g., sequentially stacked, with a separator 230 therebetween.

FIG. 7 is a cross-sectional view of a process of welding the uncoated regions of the plurality of current collecting layers via ultrasonic welding.

Referring to FIG. 7, a plurality of second electrode plates 220 may be welded to the uncoated region 203 by a welding horn T that is typically used in ultrasonic welding. In this example, since the first conductive layer F1 and the second conductive layer F2 of the current collecting layer 201A of the plurality of second electrode plates 220 are electrically connected to each other, substantially all of the second electrode plate 220 may be electrically connected. In addition, although not shown in the drawing, substantially the plurality of first electrode plates 210 may also be electrically connected to each other.

In a conventional rechargeable battery containing a resin metal composite substrate, welding the uncoated region of the electrode is challenging because the uncoated region contacts only one side of the metal layer. In order to overcome this challenge, the manufacturing process may necessitate an additional operation of performing a conduction process for achieving conduction through the metal layers.

As described above, the electrode assembly 200 according to an example embodiment may electrically connect the first electrode plates 210 to each other and the second electrode plates 220 to each other electrically using an ultrasonic welding method, even without performing a separate conduction process.

In examples, the electrode assembly 200 according to an example embodiment does not need to perform a conduction process that requires additional folding of foils and individually inserting the foils between electrode plates. Therefore, not only can the manufacturing time be shortened, but the manufacturing cost can also be reduced.

While examples of this invention have been described in connection with what is presently considered to be practical example embodiments, it is to be understood that the invention is not limited to the disclosed example embodiments. On the contrary, the example embodiments are intended to cover various modifications and equivalent arrangements included within the spirit and scope of the appended claims. Therefore, those of ordinary skill in the art will understand that numerous variations and equivalent other example embodiments are possible from this. Therefore, the true technical protection range of examples the present invention should be determined by the technical idea of the attached patent claim range.

### DESCRIPTION OF SYMBOLS

| | |
|---|---|
| 100: rechargeable battery | 200: electrode assembly |
| 201A, 201B: current collecting layer | 202: current collecting portion |
| 203: uncoated region | 204: electrode plate layer |
| 210: first electrode plate | 220: second electrode plate |
| 230: separator | 300: case |
| E: base layer | E1: body portion |
| E2: inclined portion | F1: first conductive layer |
| F2: second conductive layer | |

What is claimed is:

1. An electrode plate comprising:
a base layer;
a first conductive layer;
a current collecting layer including a first conductive layer and a second conductive layer respectively disposed on an upper surface and a lower surface of the base layer; and
an electrode plate layer on at least one side of the current collecting layer;
wherein at least a portion of the first conductive layer and at least a portion of the second conductive layer extending beyond the base layer are coupled with each other.

2. The electrode plate of claim 1, wherein the base layer comprises:
a body portion; and
an inclined portion that is integrated with the body portion, and a thickness of the inclined portion gradually decreases toward an end thereof.

3. The electrode plate of claim 1, wherein the current collecting layer comprises:
a current collecting portion, where the electrode plate layer is disposed on at least one side thereof; and
an uncoated region extending to an outside portion of the current collecting portion; and
a portion of the first conductive layer and a portion of the second conductive layer extend beyond the uncoated region, and ends thereof are coupled to each other.

4. The electrode plate of claim 1, wherein the base layer comprises at least one of poly amide, poly imide, poly butylene terephthalate, polyethylene naphthalate, poly carbonate, polyethylene, polypropylene, polyethylene propylene, acrylo nitrile-butadiene-styrene copolymer, poly vinyl alcohol, poly styrene, poly chloride vinyl, poly vinylidene fluoride, poly tetra fluoro ethylene, poly styrene sulfonate sodium, poly acetylene, silicon rubber, poly oxy methylene, poly phenylene ether, poly phenylene sulfide, polyethylene glycol, poly sulfur nitride, poly phenylene, polypyrrole, poly aniline, polythiophene, polypyridine, cellulose, farinaceous, protein, epoxy resin, phenol resin, a derivative thereof, a replacement thereof, and a copolymer thereof.

5. The electrode plate of claim 1, wherein the base layer further comprises an additive, wherein the additive comprises one or more of a metal material and an inorganic non-metal material.

6. The electrode plate of claim 1, wherein at least one of the first conductive layer and the second conductive layer comprises aluminum.

7. The electrode plate of claim 1, wherein the first conductive layer and the second conductive layer comprise one or more of nickel, copper, iron, and alloys thereof.

8. The electrode plate of claim 1, wherein the first conductive layer and the second conductive layer comprise one or more of a metal material, a carbon-based conductive material, and a conductive polymer material.

9. An electrode assembly comprising a plurality of electrode plates and a separator, the plurality of electrode plates being stacked with the separator therebetween,
wherein at least one of the plurality of electrode plates comprises:
a current collecting layer including a base layer, a first conductive layer and a second conductive layer disposed on an upper surface and a lower surface of the base layer, respectively, extend longer than the base layer, and are at least partially combined with each other; and
an electrode plate layer in a portion of the current collecting layer.

10. The electrode assembly of claim 9, wherein a thickness of one end portion of the base layer gradually decreases.

11. The electrode assembly of claim 9, wherein the base layer comprises:
a body portion; and
an inclined portion that is integrated with the body portion, wherein a thickness of the inclined portion gradually decreases toward an end thereof.

12. The electrode assembly of claim 9, wherein current collecting layers contained in the plurality of electrode plates are combined with each other.

13. The electrode assembly of claim 9, wherein the current collecting layer comprises:
a current collecting portion, the electrode plate layer being disposed on at least one side thereof; and
an uncoated region extending to an outside portion of the current collecting portion.

14. The electrode assembly of claim 9, wherein the plurality of electrode plates comprise a first electrode plate and a second electrode plate.

15. The electrode assembly of claim 9, wherein the base layer comprises at least one of poly amide, poly imide, poly butylene terephthalate, polyethylene naphthalate, poly carbonate, polyethylene, polypropylene, polyethylene propylene, acrylo nitrile-butadiene-styrene copolymer, poly vinyl alcohol, poly styrene, poly chloride vinyl, poly vinylidene fluoride, poly tetra fluoro ethylene, poly styrene sulfonate sodium, poly acetylene, silicon rubber, poly oxy methylene, poly phenylene ether, poly phenylene sulfide, polyethylene glycol, poly sulfur nitride, poly phenylene, polypyrrole, poly aniline, polythiophene, polypyridine, cellulose, farinaceous, protein, epoxy resin, phenol resin, a derivative thereof, a replacement thereof, and a copolymer thereof.

16. The electrode assembly of claim 9, wherein the base layer further comprises an additive, wherein the additive comprises one or more of a metal material and an inorganic non-metal material.

17. The electrode assembly of claim 9, wherein at least one of the first conductive layer and the second conductive layer comprises aluminum.

18. The electrode assembly of claim 1, wherein at least one of the first conductive layer and the second conductive layer comprises one or more of nickel, copper, iron, and alloys thereof.

19. The electrode assembly of claim 9, wherein at least one of the first conductive layer and the second conductive layer comprises one or more of a metal material, a carbon-based conductive material, and a conductive polymer material.

20. A rechargeable battery comprising:
an electrode assembly; and
a case containing the electrode assembly of claim 9.
